(19) United States
(12) Patent Application Publication
(10) Pub. No.: US 2020/0319845 A1
(43) Pub. Date: Oct. 8, 2020

(54) AUTOMATED CONTENT ON A VEHICLE IN MOTION

(71) Applicant: Rovi Guides, Inc., San Jose, CA (US)

(72) Inventors: David D. Shoop, San Jose, CA (US); Dylan M. Wondra, Mountain View, CA (US)

(21) Appl. No.: 16/555,374

(22) Filed: Aug. 29, 2019

Related U.S. Application Data
(60) Provisional application No. 62/830,821, filed on Apr. 8, 2019.

(51) Int. Cl. G06F 3/16; G06F 3/0481; G06F 3/0482; G06F 3/0483; G06F 3/0484

(52) U.S. Cl. CPC G06F 3/165; G06F 3/04817; G06F 3/0484; G06F 3/0483; G06F 3/0482

(57) ABSTRACT

Systems and methods for providing content on a vehicle are disclosed herein. When the vehicle is in motion, an audio user interface element is displayed on a user interface. Upon selection of the user interface element, a plurality of audio content identifiers are displayed on the user interface. When the vehicle is in motion, the user interface excludes a video user interface element. When it is determined the vehicle is not in motion, both the audio user interface element and the video user interface are displayed on the user interface. Upon selection of the video user interface element a plurality of video content identifiers are displayed on the user interface.

### CROSS-REFERENCE TO RELATED APPLICATIONS

This application claims priority to U.S. Provisional Application No. 62/830,821, filed Apr. 8, 2019, which is incorporated herein by reference in its entirety.

### BACKGROUND

The present disclosure relates to providing content while a vehicle is in motion.

### SUMMARY

Some vehicles include entertainment consoles that provide users with a wide array of content including video content. A user interface in such vehicles may include a video tab among other tabs such as a music tab, a radio tab, a podcast tab etc. When the video tab is opened, the user interface displays several selectable video content identifiers which, when selected, lead to presentation of the selected video. Providing video content when the vehicle is in motion, however, can be dangerous to the driver and the passengers in the vehicle because it may distract the driver.

Consequently, when the vehicle is in motion, the video tab may be greyed out or otherwise un-selectable. Such an approach consumes limited user interface space by cluttering it with unnecessary unelectable elements and warnings. Although, the tab may remain selectable, when the user attempts to select the video tab, a message is displayed on the interface indicating that access to video is restricted. This approach is unnecessarily dangerous because the driver may still become distracted when trying to select an un-selectable tab or when reading a message about unavailability of video.

Accordingly, to overcome the problems of these approaches described herein are various systems and methods for automatically checking the speed of the vehicle and completely excluding the video tab from being displayed on the user interface when the vehicle is in motion. Any warnings regarding availability of video may also be excluded from the user interface. The video tab may automatically appear when the vehicle stops or becomes parked. In some embodiments, when the vehicle is in motion, the user interface displays an audio tab but excludes a video tab. When the vehicle is in not in motion, the user interface displays both the audio tab and the video tab where the tabs are selectable to, respectively, display audio and content identifiers which are used to select corresponding content for presentation. In one embodiment, the additional space provided on the user interface is used to display another tab. In another embodiment, the tabs are resized to be larger in order to simplify user access.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative example of a vehicle content interface application for displaying content in a vehicle in accordance with some embodiments of the disclosure;

FIG. 2 depicts a block diagram of an illustrative example of a user equipment device in accordance with some embodiments of the disclosure;

FIG. 3 depicts an example of an illustrative system implementing the user equipment device in accordance with some embodiments of the disclosure;

FIG. 4 depicts an illustrative example of a vehicle featuring a content display in accordance with some embodiments of the disclosure;

FIG. 5 depicts an illustrative example of a vehicle content interface application for displaying content in a vehicle when the vehicle is in motion in accordance with some embodiments of the disclosure;

FIGS. 6A and 6B depicts an illustrative example of a vehicle content interface application when the vehicle is not in motion in accordance with some embodiments of the disclosure;

FIG. 7A depicts illustrative examples of a vehicle content interface application for displaying content in a vehicle when the vehicle is not in motion.

FIG. 7B depicts illustrative examples of a vehicle content interface application for displaying content in a vehicle when the vehicle is in motion.

FIG. 8 depicts an illustrative flowchart of a process for providing content on a vehicle, in accordance with some embodiments of the disclosure.

### DETAILED DESCRIPTION

Methods and system are disclosed herein for automatically providing content on a vehicle. In one embodiment, when the vehicle is in motion, the method displays an audio tab to a user in a vehicle and fully excludes a video tab when the vehicle is motion. In another embodiment, when the vehicle is not in motion, the method displays both audio and video tab to the user in the vehicle.

As used herein, “a vehicle content interface application” refers to a form of content through an interface that facilitates access to audio, music, podcast and video content. In some embodiments, the vehicle content interface application may be provided as an on-line application (i.e., provided on a website), or as a stand-alone application on a server, user device, etc. Various devices and platforms that may implement the vehicle content interface application are described in more detail below. In some embodiments, the vehicle content interface application and/or any instructions for performing any of the embodiments discussed herein may be encoded on computer readable media. Computer readable media includes any media capable of storing instructions and/or data. The computer readable media may be transitory, including, but not limited to, propagating electrical or electromagnetic signals, or may be non-transitory including, but not limited to, volatile and nonvolatile computer memory or storage devices such as a hard disk, floppy disk, USB drive, DVD, CD, media card, register memory, processor caches, Random Access Memory (“RAM”), etc.

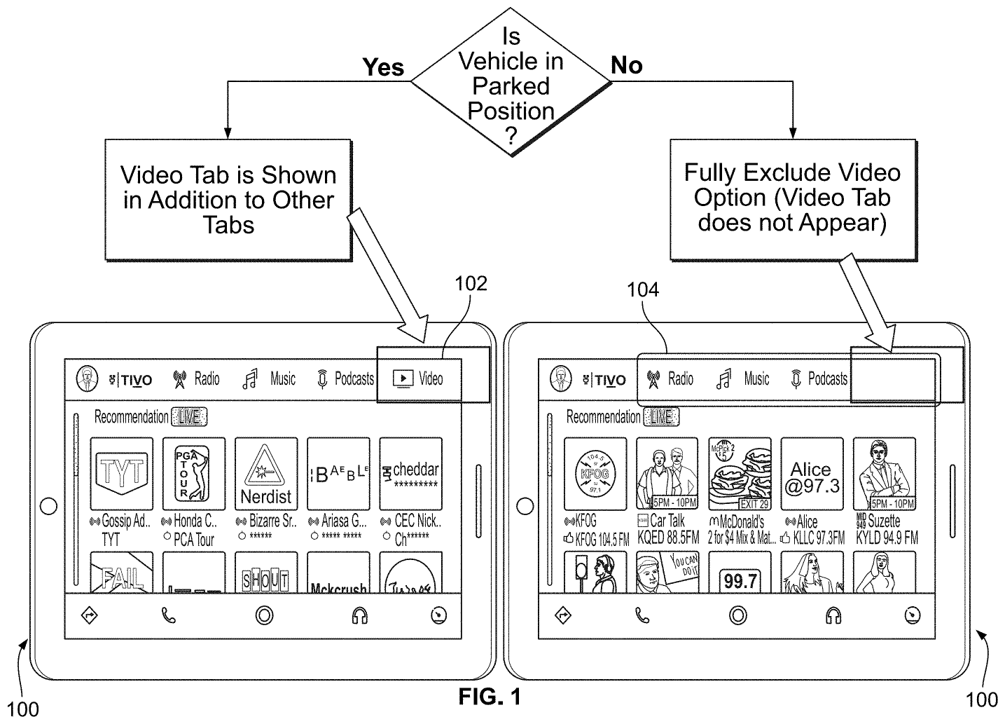

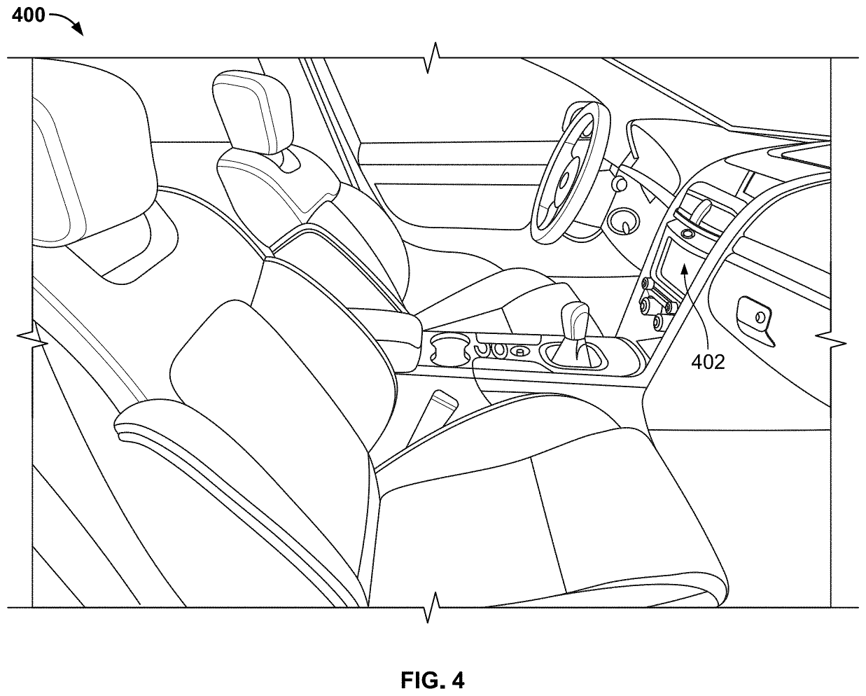

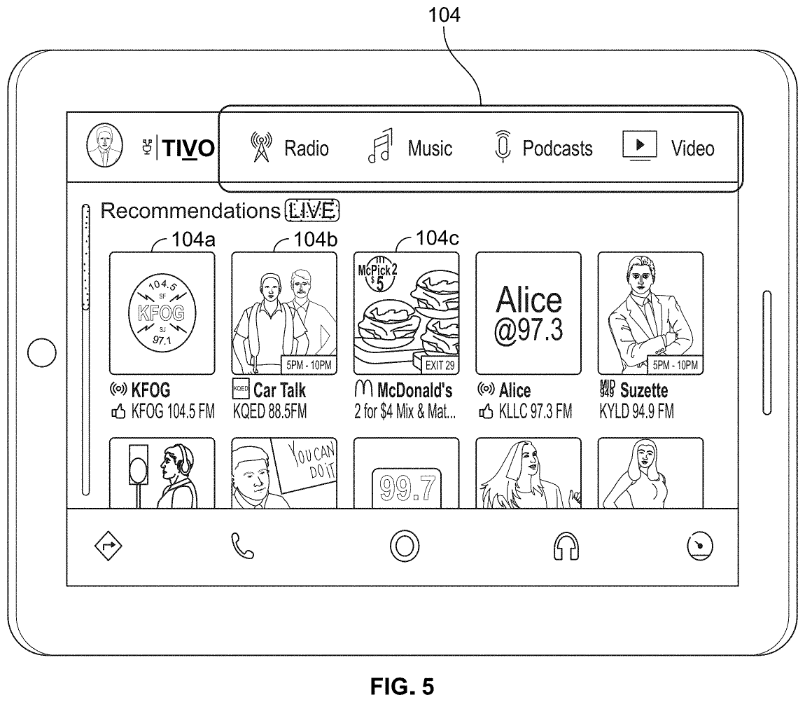

FIG. 1 shows an illustrative display screen 100 that is available to a user occupying a vehicle (e.g. vehicle 400 of FIG. 4). In one embodiment, as shown in, the vehicle content interface application may analyze vehicular data such as the vehicle speed in order to determine whether the vehicle is in a parked position i.e. the vehicle is not in motion. In one example, when it is determined the vehicle is in the parked position, i.e. the vehicle is not in motion the vehicle content interface application may display a video user interface element (video tab 102) on the display screen 100. The screen 100 may also display audio user interface element (radio tab) 104 among other user interface elements (tabs), which are discussed below with reference to FIG. 5. In one example, when it is determined the vehicle is not in a parked position, the vehicle content interface application may display the radio tab 104 on the display screen 100 and fully excludes the video tab 102 from the display screen 100. In one embodiment, any data associated with the video tab 102 is excluded from the display screen 100.

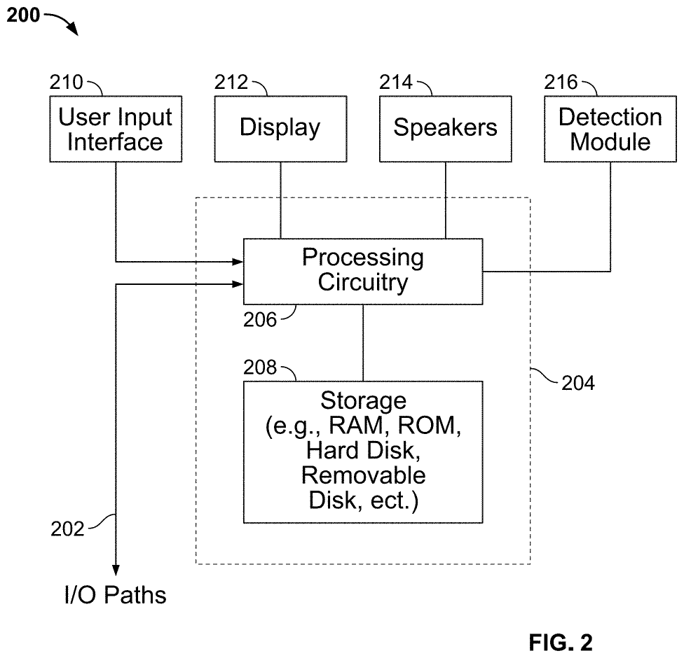

Users in a vehicle may access content and the vehicle content interface application (and its display screens described above and below) from one or more of their user equipment devices. FIG. 2 shows a generalized embodiment of illustrative user equipment device 200. More specific implementations of user equipment devices are discussed below in connection with FIG. 4. User equipment device 200 may receive content and data via input/output (hereinafter “I/O”) path 202. I/O path 102 may provide content (e.g., broadcast programming, on-demand programming, Internet content, content available over a local area network (LAN) or wide area network (WAN), and/or other content) and data to control circuitry 204, which includes processing circuitry 206 and storage 108. Control circuitry 204 may be used to send and receive commands, requests, and other suitable data using I/O path 202.

Control circuitry 204 may be based on any suitable processing circuitry such as processing circuitry 206. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, In some embodiments, control circuitry 204 executes instructions for a vehicle content interface application stored in memory (i.e., storage 208). Specifically, control circuitry 204 may be instructed by the vehicle content interface application to perform the functions discussed above and below. For example, the vehicle content interface application may provide instructions to control circuitry 204 to generate the audio content display or combination of audio and video content displays. In some implementations, any action performed by control circuitry 204 may be based on instructions received from the vehicle content interface application.

In client-server-based embodiments, control circuitry 204 may include communications circuitry suitable for communicating with a content application server or other networks or servers. The instructions for carrying out the above-mentioned functionality may be stored on the content application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 208 that is part of control circuitry 204. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 208 may be used to store various types of content described herein as well as content data and content application data that are described above. Nonvolatile memory may also be used (e.g., to launch a boot-up routine and other instructions). Cloud-based storage, may be used to supplement storage 208 or instead of storage 208.

Control circuitry 204 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 204 may also include scaler circuitry for upconverting and downconverting content into the preferred output format of the user equipment 200. Circuitry 204 may also include digital-to-analog converter circuitry and analog-to-digital converter circuitry for converting between digital and analog signals. The tuning and encoding circuitry may be used by the user equipment device to receive and to display, to play, or to record content.

In one embodiment, speakers 214 may be provided as integrated with other elements of user equipment device 200 or may be stand-alone units. The audio component of videos and other content displayed on display 212 may be played through speakers 214. In some embodiments, the audio may be distributed to a receiver (not shown), which processes and outputs the audio via speakers 214.

In one embodiment, sensor 216 is provided in the user equipment device 200. The sensor 216 may be used to monitor, identify, and determine vehicular data. For example, the vehicle content interface application may receive vehicular speed data from the sensor 216 or any other vehicular status data (e.g. global positioning data of the vehicle, driving condition of the vehicle etc.) received from any other vehicular circuitry and/or component that describes the vehicular status of the vehicle.

The vehicle content interface application may be implemented using any suitable architecture. For example, it may be a stand-alone application wholly implemented on user equipment device 200. In such an approach, instructions of the application are stored locally (e.g., in storage 208), and data for use by the application is downloaded on a periodic basis (e.g., from an out-of-band feed, from an Internet resource, or using another suitable approach). Control circuitry 204 may retrieve instructions of the application from storage 208 and process the instructions to generate any of the displays discussed herein. Based on the processed instructions, control circuitry 204 may determine what action to perform when input is received from input interface 210. For example, movement of a cursor on an audio user interface element or a video user interface element may be indicated by the processed instructions when input interface 210 indicates that a radio tab 104 or the video tab 102 was selected.

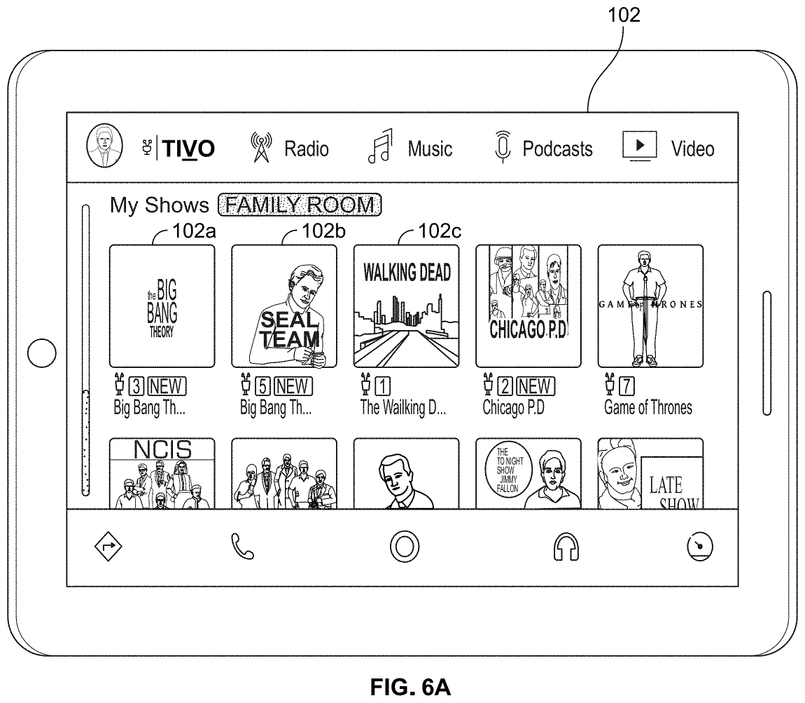

In some embodiments, the vehicle content interface application is a client-server based application. Data for use by a thick or thin client implemented on user equipment device 200 is retrieved on-demand by issuing requests to a server remote to the user equipment device 200. In one example of a client-server based content application, control circuitry 204 runs a web browser that interprets web pages provided by a remote server. For example, the remote server may store the instructions for the application in a storage device. The remote server may process the stored instructions using circuitry (e.g., control circuitry 204) and generate the displays discussed above and below. The client device may receive the displays generated by the remote server and may display the content of the displays locally on equipment device 200. This way, the processing of the instructions is performed remotely by the server while the resulting displays are provided locally on equipment device 200. Equipment device 200 may receive inputs from the user via input interface 210 and transmit those inputs to the remote server for processing and generating the corresponding displays. For example, equipment device 200 may transmit a communication to the remote server indicating that a user interface element was selected via input interface 210. The remote server may process instructions in accordance with that input and generate a display of content identifiers associated with the selected user interface element as described in greater detail with reference to FIG. 5, FIG. 6A and 6B. The generated display is then transmitted to equipment device 200 for presentation to the user.

In some embodiments, the vehicle content interface application is downloaded and interpreted or otherwise run by an interpreter or virtual machine (run by control circuitry 204). In some embodiments, the vehicle content interface application may be encoded in the ETV Binary Interchange Format (EBIF), received by control circuitry 204 as part of a suitable feed, and interpreted by a user agent running on control circuitry 204. For example, the vehicle content interface application may be an EBIF application. In some embodiments, the vehicle content interface application may be defined by a series of JAVA-based files that are received and run by a local virtual machine or other suitable middleware executed by control circuitry 204. In some of such embodiments (e.g., those employing MPEG-2 or other digital media encoding schemes), the vehicle content interface application may be, for example, encoded and transmitted in an MPEG-2 object carousel with the MPEG audio and video packets of a program.

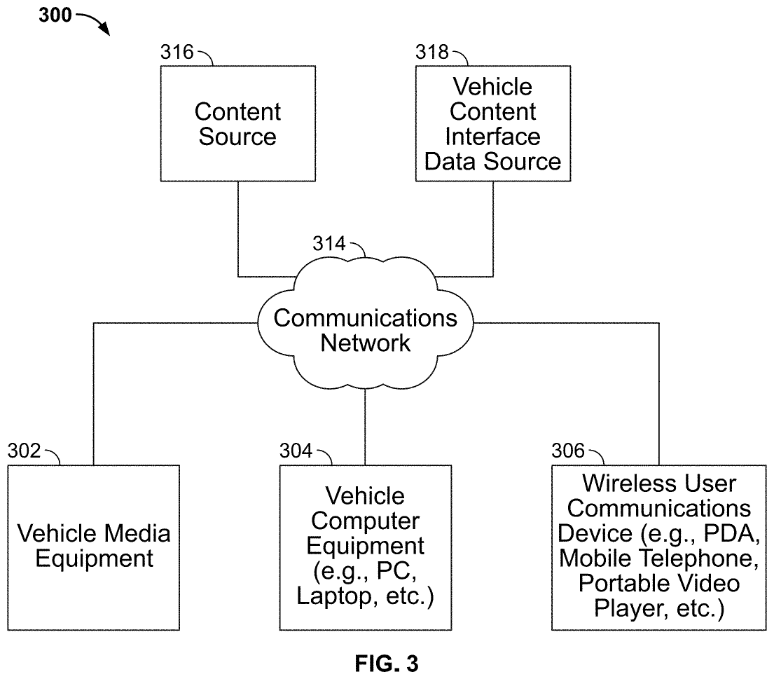

User equipment device 200 of FIG. 2 can be implemented in system 300 of FIG. 3 as vehicle media equipment 302, vehicle computer equipment 304, wireless user communications device 306, or any other type of user equipment suitable for accessing content, such as a non-portable gaming machine. For simplicity, these devices may be referred to herein collectively as user equipment or user equipment devices and may be substantially similar to user equipment devices described above. User equipment devices, on which a vehicle content interface application may be implemented, may function as a standalone device or may be part of a network of devices. Various network configurations of devices may be implemented and are discussed in more detail below.

In one embodiment , user equipment may refer to components incorporated into, coupled to, or accessible by a vehicle such as vehicle 400 in FIG. 4. The vehicle 400 is equipped with a vehicle content interface application that may be used to enable/disable content options. For example, a user in vehicle 400 may use vehicle content interface component 402 to access content on the vehicle 400. In some embodiments, the vehicle content interface component 402 may be an audio and/or video system incorporated into vehicle 400 or user equipment used to access such content while using vehicle 400.

A user equipment device utilizing at least some of the system features described above in connection with FIG. 2 may not be classified solely as vehicle media equipment 302, vehicle computer equipment 304, or a wireless user communications device 306. For example, vehicle media equipment 302 may, like some vehicle computer equipment 304, be Internet-enabled allowing for access to Internet content, while user computer equipment 304 may, like some vehicle media equipment 302, include a tuner allowing for access to media programming. The vehicle content interface application may have the same layout on various types of user equipment or may be tailored to the display capabilities of the user equipment. For example, on user computer equipment 304, the vehicle content interface application may be provided as a web site accessed by a web browser. In another example, the vehicle content interface application may be scaled down for wireless user communications devices 306.

The user equipment devices may be coupled to communications network 314. Communications network 314 may be one or more networks including the Internet, a mobile phone network, mobile voice or data network (e.g., a 4G or LTE network), cable network, public switched telephone network, or other types of communications network or combinations of communications networks.

System 300 includes content source 316 and vehicle content interface data source 318 coupled to communications network 314. Communications with the content source 316 and the data source 318 may be exchanged over one or more communications paths but are shown as a single path in FIG. 3 to avoid overcomplicating the drawing. Although communications between sources 316 and 318 with user equipment devices 302, 304, and 306 are shown as through communications network 314, in some embodiments, sources 316 and 318 may communicate directly with user equipment devices 302, 304, and 306.

Content source 316 may include one or more types of content distribution equipment including a media distribution facility, cable system headend, satellite distribution facility, programming sources, intermediate distribution facilities and/or servers, Internet providers, on-demand media servers, and other content providers. Vehicle Content Interface data source 318 may provide content data, such as the audio and video data described above. Vehicle content interface application data may be provided to the user equipment devices using any suitable approach. In some embodiments, vehicle content interface data from vehicle content interface data source 318 may be provided to users' equipment using a client-server approach. For example, a user equipment device may pull content data from a server, or a server may the content data to a user equipment device. Data source 318 may provide user equipment devices 302, 304, and 306 the vehicle content interface application itself or software updates for the vehicle content interface application.

In some embodiments, the content source 316 includes video data that was previously recorded in the DVR with an option to make this recorded video content available for viewing in the vehicle 400. In one embodiment, when the vehicle is not in motion, the vehicle content interface application may provide an option to the user to watch the recorded video content on the screen 100 (either automatically or upon user's selection) via a network-accessible cloud computing and cloud-based storage (cloud computing environment) operated in user equipment devices such as the vehicle media equipment 302, the vehicle computer device 304 and/or the wireless user communications device 306. In another embodiment, when the vehicle is not in motion, the vehicle content interface application may provide an option to the user to watch the recorded video content (either automatically or upon user's selection) in the wireless user communication device 306 via a blue tooth communication.

In some embodiments, vehicle content interface application may provide advertisements on the display screen 100 based on a current location of the vehicle 400 and the recorded video content. The current location may be determined using a global positioning system (GPS) in the vehicle 400. The current locations may include original or beginning position of the vehicle 400, en route of the vehicle 400 (between original position and destination) and the destination of the vehicle 400. For example, the recorded video content includes content related to fast food and a fast food restaurant such as McDonald's is in the current location of the vehicle, an advertisement of McDonalds® may be displayed on the display screen 100.

As discussed above, in some embodiments, when the vehicle 400 is in motion, other tabs besides radio tab 104 are also displayed on the screen 100 of the vehicle content interface component 402 and the video tab 102 is fully excluded from the screen 100. Other tabs may include a music tab 106 and a podcast tab 108 as shown in FIG. 5. In one example, a user in the vehicle 400 may select the radio tab 104 via a user interface (e.g., user input interface 210 (FIG. 2)) incorporated into or accompanying the vehicle content interface component 402 by direct input into the user interface (e.g., activating the system via selectable option 104 (FIG. 1). Upon user's selection of the radio tab 104, a list of audio content identifiers 104a, 104b, 104c . . . 104n are displayed on the display screen 100 as shown in FIG. 5. When the user selects one of the audio identifiers 104a . . . 104n via the user interface (e.g., user input interface 210 (FIG. 2)) incorporated into or accompanying the vehicle content interface component 402, the selected audio content corresponding to the audio identifier is displayed on the screen. In other embodiments, when the video tab 102 is fully excluded from the screen 100 while the vehicle 400 is in motion, the user may be able to listen to audio part of a video corresponding to the video tab 102. In other words, the user can listen to video programs such as news, sports or other programming corresponding to the video tab 102 when the vehicle is in motion.

In other embodiments. when the vehicle 400 is not in motion, the video tab 102, the radio tab 104, the audio tab 106 and the podcast tab 108 are displayed on the screen 100 as shown in FIG. 6A. The user may select a video interface element (video tab) 102 via the user interface (e.g., user input interface 210 (FIG. 2)) incorporated into or accompanying the vehicle content interface component 402. Upon user's selection of the video tab 102, the vehicle content interface application may display a list of video content identifiers 102a, 102b, 102c . . . 102n on the display screen 100 as shown in FIG. 6A. When the user selects one of the video identifiers 102a . . . 102n, for example, via the user interface (e.g., user input interface 210 (FIG. 2)) incorporated into or accompanying the vehicle content interface component 402, the vehicle content interface application displays the selected video content corresponding to the audio identifier on the screen. For example, the video identifier 102c corresponds to a TV show “The Walking Dead” and the user selects this video identifier 102, content of the “The Walking Dead” show will be displayed on the screen 100 at FIG. 6B. Accordingly, the user can watch the “The Walking Dead” show. In one example the user starts driving the vehicle, thus the vehicle is now in motion and the video tab 102 is excluded from the display screen 100, however, the user can still listen to the audio such as dialogues, music etc. of the “Walking Dead” show.

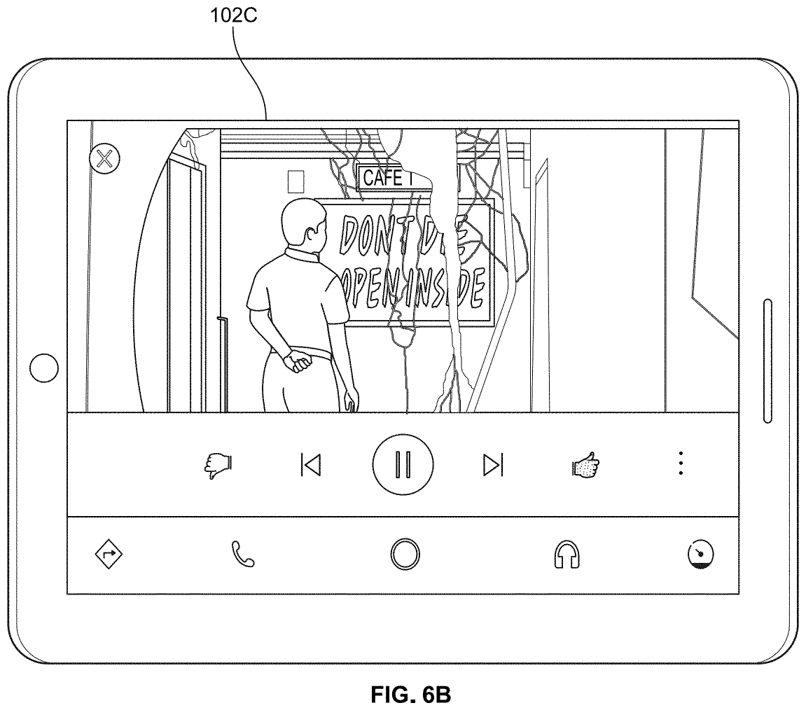

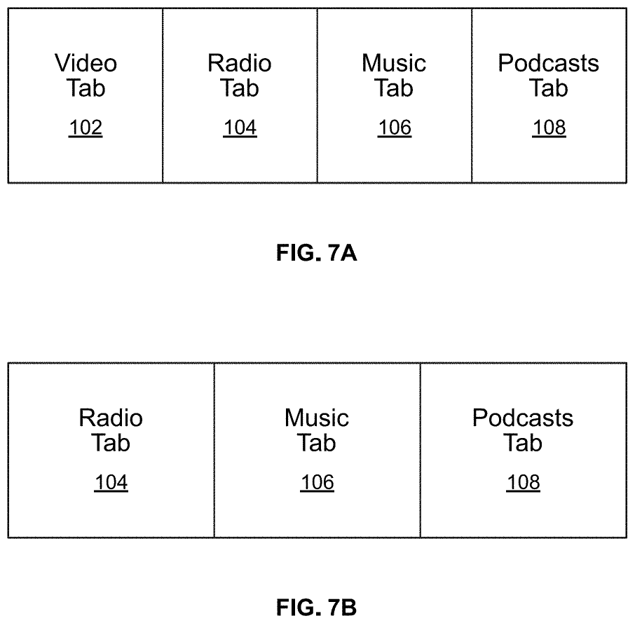

In one embodiment, when the vehicle 400 is not in motion, the vehicle content interface application displays the video tab 102, the radio tab 104, the music tab 106 and the podcast tab 108 on the screen 100 as shown in an example in FIG. 7A. In one example, such tabs are displayed as regular or normal in size. As discussed above, when the vehicle 400 is in motion, the vehicle content interface application excludes the video tab 102 from the screen 100, which results in additional space on the screen 100. In one embodiment, vehicle content interface application may increase size of the radio, music and podcast tabs 104, 106 and 108 respectively to utilize the additional space as shown in the display screen in FIG. 7B. In another example, when the vehicle 400 changes to a parked position (i.e. not in motion), the vehicle content interface application decreases the sizes of the radio, music and podcast tabs 104, 016 and 108 respectively, for example back to their normal size in display the video tab 102 in the additional space as shown in FIG. 7A.

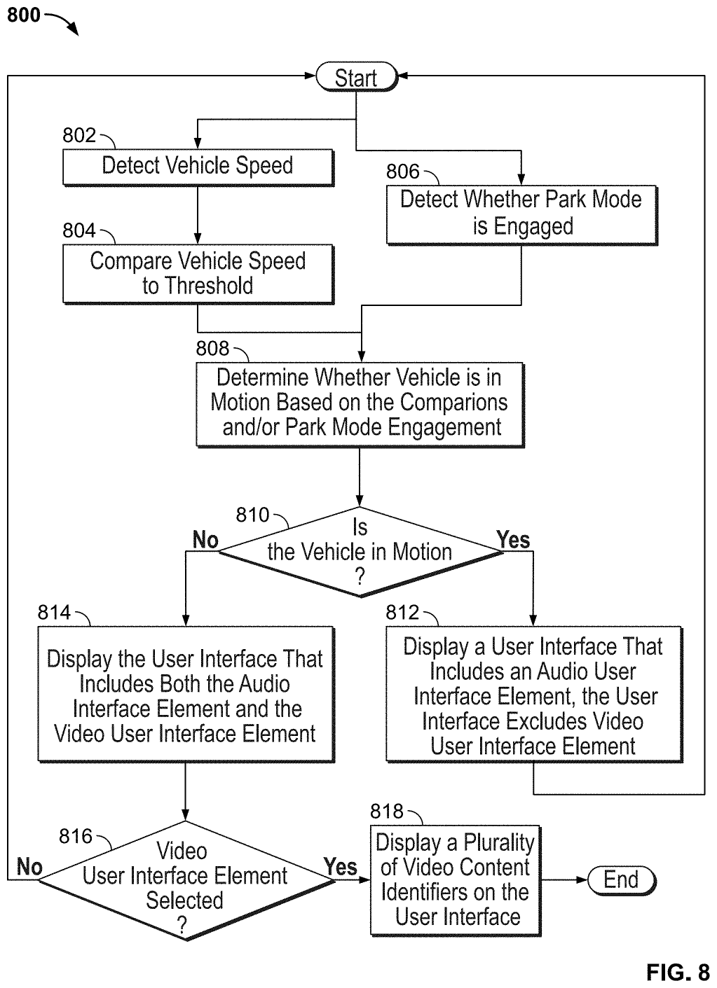

FIG. 8 depicts an illustrative flowchart of process 800 for providing content on a vehicle, in accordance with some embodiments of the disclosure. At 802, control circuitry 220 detects vehicle speed, which may be generated via the sensor 216. At 804, control circuity 220 compares vehicle speed with a threshold. Alternatively, or in addition at 806, control circuitry 220 detects whether a parked mode is engaged in the vehicle. At 808, control circuity 220 determines whether vehicle is in motion based on the comparison between the vehicle speed and the threshold at 804 and/or upon the detection of whether a parked mode is engaged at 806. At block 810, the control circuity 220 determines either the vehicle is in motion or not in motion. If the control circuitry 220 determines that the vehicle is in motion (“Yes” at 810), then at 812, the control circuitry 220 displays on the vehicle, a user interface that includes an audio interface element; the user interface excludes a video interface element. Then the process 802, 804, alternatively or additionally 806, 808 and 810 are repeated. If, on the other hand, control circuitry 220 determines that the vehicle is not in motion (“No” at 810), then at 814, the control circuitry 220 displays the user interface that includes both the audio interface element and the video interface element.

At block 816, the control circuitry 220 determines whether the video user interface element is selected. In one example the video user interface element is selected by a user in the vehicle. If the control circuitry 220 determines that the video interface element is selected (“Yes” at 816), then at 818, control circuitry 220 displays a plurality of video content identifiers corresponding to the selected video interface element on the user interface. Then the process 800 terminates. If on the other hand, control circuitry 220 determines that the video interface element is not selected (“No” at 816), then the process 802, 806, 808, and 810 are repeated.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
while a vehicle is in motion, displaying a user interface, the user interface comprising an audio user interface element, wherein selection of the audio user interface element results in a display of a plurality of audio content identifiers;
wherein, while the vehicle is in motion, the user interface excludes a video user interface element;
determining that the vehicle is not in motion; and
in response to the determining that the vehicle is not in motion, displaying the user interface, the user interface comprising the audio user interface element and the video user interface element, wherein selection of the video user interface element results in a display of a plurality of video content identifiers.

2. The method of claim 1 wherein the determining that the vehicle is not in the motion comprises determining that the vehicle is in a parked position.

3. The method of claim 1 wherein selection of a video content identifier among the plurality of video identifiers results in a display of a video content associated with the selected video content identifier.

4. The method of claim 3 wherein the video content is one of a live streaming video content or a stored video content.

5. The method of claim 1, further comprising:
in response to receiving user input to view one of the plurality of video content identifiers, displaying video content associated with the selected video content identifier.

6. The method of claim 1 further comprising:
while the vehicle is not in motion, displaying one of a podcast user interface element, a radio user interface element or a music user interface element on the user interface.

7. The method of claim 6, further comprising:
while the vehicle is not in motion, decreasing size of the video user interface element, the podcast user interface element, the radio user interface element and the music user interface element on the user interface.

8. The method of claim 1 further comprising:
while the vehicle is in motion, displaying one of a podcast user interface element, a radio user interface element or a music user interface element on the user interface.

9. The method of claim 1 further comprising:
while the vehicle is in motion, increasing size of the podcast user interface element, the radio user interface element and the music user interface element on the user interface.

10. The method of claim 1 wherein the selection of one of the audio user interface element or the video user interface element is provided by a user in the vehicle.

11. A system comprising:
a sensor configured to determine whether a vehicle is in motion;
a control circuitry coupled to the sensor, the control circuitry is configured to:
while the vehicle is in motion, display an audio user interface element on a user interface, wherein upon selection of the audio user interface element, display a plurality of audio content identifiers on the user interface, wherein while the vehicle is in motion, the user interface excludes a video user interface element;
while the vehicle is not in motion, display the user interface comprising the audio user interface element and the video user interface element, wherein upon selection of the video user interface element, display a plurality of video content identifiers on the user interface.

12. The system of claim 11, wherein to determine that the vehicle is not in the motion comprises the control circuitry to determine that the vehicle is in a parked position.

13. The system of claim 11 wherein upon the selection of a video content identifier among the plurality of video identifiers, the control circuitry is configured to display a video content associated with the selected video content identifier.

14. The system of claim 13 wherein the video content is one of a live streaming video content or a stored video content.

15. The system of claim 11 wherein in response to receiving user input to view one of the plurality of video content identifiers, the control circuitry to display video content associated with the selected video content identifier.

16. The system of claim 11 wherein while the vehicle is not in motion, the control circuitry is configured to display one of a podcast user interface element, a radio user interface element or a music user interface element on the user interface.

17. The system of claim 16 wherein while the vehicle is not in motion, the control circuitry is configured to decrease size of the video user interface element, the podcast user interface element, the radio user interface element and the music user interface element on the user interface.

18. The system of claim 11 wherein while the vehicle is in motion, the control circuitry is configured to display one of a podcast user interface element, a radio user interface element or a music user interface element on the user interface.

19. The system of claim 18 wherein while the vehicle is in motion, the control circuitry is configured to increase size of the podcast user interface element, the radio user interface element and the music user interface element on the user interface.

20. The system of claim 11 wherein the selection of one of the audio user interface element or the video user interface element is provided by a user in the vehicle.

21.-30. (canceled)
